(19) United States
(12) Patent Application Publication
(10) Pub. No.: US 2002/0111973 A1
(43) Pub. Date: Aug. 15, 2002

(54) METHOD OF CONTROLLING WEB BROWSER DOCUMENT IMAGE DOWNLOADS AND DISPLAYS

(76) Inventors: JOHN MADDALOZZO JR., AUSTIN, TX (US); GERALD FRANCIS MCBREARTY, AUSTIN, TX (US); JOHNNY MENG-HAN SHIEH, AUSTIN, TX (US)

Correspondence Address: MR VOLEL EMILE, P O BOX 202170, AUSTIN, TX, 78720-2170, US

(21) Appl. No.: 09/173,040

(22) Filed: Oct. 15, 1998

(51) Int. Cl. G06F 15/00

(52) U.S. Cl. 707/526

(57) ABSTRACT

An apparatus and method of controlling the download and display of images within a web browser are provided. The method and apparatus allow a user to selectively control either one or a plurality of images currently being downloaded and displayed by the web browser. For example, the user may terminate or suspend the download of any or all of a plurality of images being downloaded or displayed within a web page or frame. The user may later resume the download or display of any or all of the images whose downloads had been suspended.

### BACKGROUND OF THE INVENTION

1. Field of the Invention

The present invention relates to user interactive computer supported display technology and particularly to such user interactive systems and methods which are user friendly and provide easy to use interactive user interfaces.

2. Description of the Related Art

The 1990's decade has been marked by a technological revolution driven by the convergence of the data processing industry with the consumer electronics industry. This advance has been even further accelerated by the extensive consumer and business involvement in the internet over the past few years. As a result of these changes, it seems as if virtually all aspects of human endeavor in the industrialized world requires the distribution of information through interactive computer display interfaces. Information for reporting, marketing, technology and educational purposes, which in the past was permitted days and even months for distribution, are now customarily required to be “on-line” in a matter of hours and even minutes. The electronic documents through which such information is distributed is made up of pages, e.g. internet web pages of a variety of information types, e.g. text, graphics, photographs and even more complex image types. Because of the limited time factors involved in the creation, updating and reading of computer displayed documents, there is a need for methods and systems for navigating through these documents which are fast and relatively effective.

In addition, with the emergence of desktop publishing in all areas of publishing: periodicals, newspapers, technical journals, business reports, etc., the need for an effective method to navigate through pages of these documents has been further reinforced. The present invention is directed toward satisfying this need.

### SUMMARY OF THE INVENTION

The present invention provides an apparatus and method of controlling web browser documents. The method and apparatus allow a user to selectively stop, suspend, and continue the download and display of any or all of a plurality of images being downloaded and displayed by a web browser when a web page or frame is being downloaded and displayed.

### BRIEF DESCRIPTION OF THE DRAWING

FIG. 1 is a typical data processing system which may function as the computer controlled display terminal used in implementing the present invention.

FIGS. 2, 3, 4 and 5 are depictions of a browser used in the present invention.

FIG. 6 is a flowchart of the process used in implementing the present invention.

### DESCRIPTION OF THE INVENTION

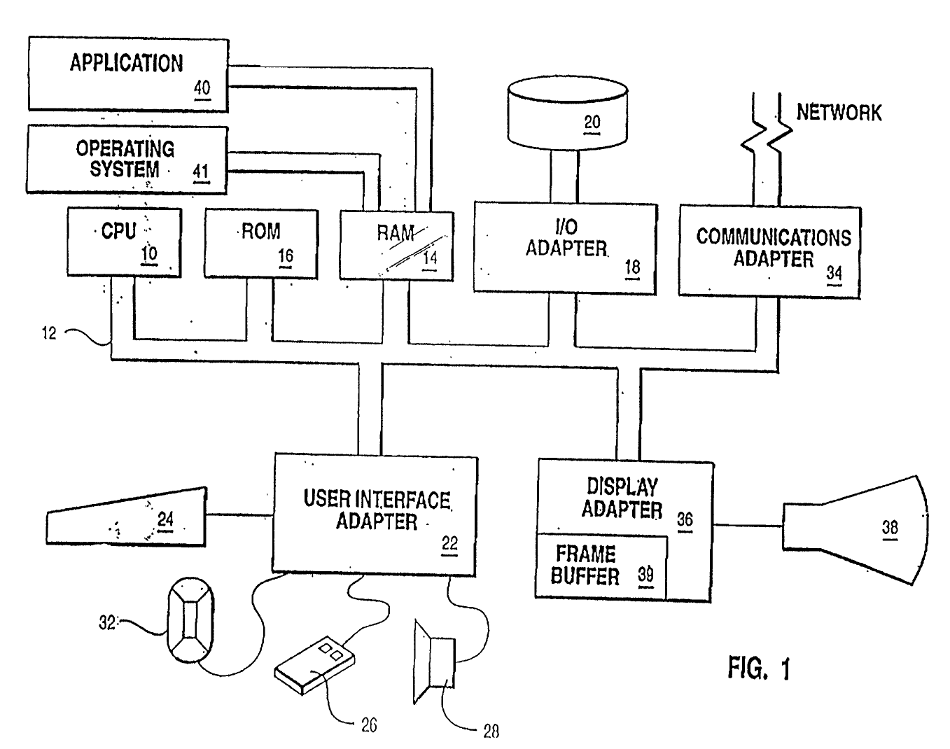

Referring to FIG. 1, a typical data processing system is shown which may function as the computer controlled display terminal used in implementing the present invention. A central processing unit (CPU) 10, such as one of the PC microprocessors available from International Business Machines Corporation (IBM), is provided and interconnected to various other components by system bus 12. An operating system 41 runs on CPU 10 and provides control. The operating system 41 also coordinates the function of the various components of FIG. 1. The operating system 41 may be one of the commercially available operating systems such as the OS/2 operating system available from IBM (OS/2 is a trademark of IBM); Microsoft's Windows 95™, Windows 98™ or Windows NT™, as well as UNIX or AIX operating systems.

A program for controlling web browser image downloads, application 40, to be subsequently described in detail, runs in conjunction with the operating system 41. Application 40 provides output calls to the operating system 41. The operating system 41 implements, inter alia, the various functions performed by the application 40.

A read only memory (ROM) 16 is connected to CPU 10 via bus 12 and includes the basic input/output system (BIOS) that controls the basic computer functions. Random access memory (RAM) 14, I/O adapter 18 and communications adapter 34 are also interconnected to system bus 12. It should be noted that software components, including the operating system 41 and the application 40, are loaded into RAM 14, which is the computer system's main memory. I/O adapter 18 may be a small computer system interface (SCSI) adapter that communicates with the disk storage device 20, i.e. a hard drive. Communications adapter 34 interconnects bus 12 with an outside network enabling the data processing system to communicate with other systems over a local area network (LAN), wide area network (WAN) which includes, of course, the internet. I/O devices are also connected to system bus 12 via user interface adapter 22 and display adapter 36. Keyboard 24, trackball 32, mouse 26 and speaker 28 are all interconnected to bus 12 through user interface adapter 22.

Display adapter 36 includes a frame buffer 39 which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24, trackball 32 or mouse 26 and receiving output information from the system via speaker 28 and display 38. In the preferred embodiment, which will be subsequently described, the mouse will be the input means through which the user will interface with the system. The display terminal of FIG. 1 communicates with the network through the communications adapter 34.

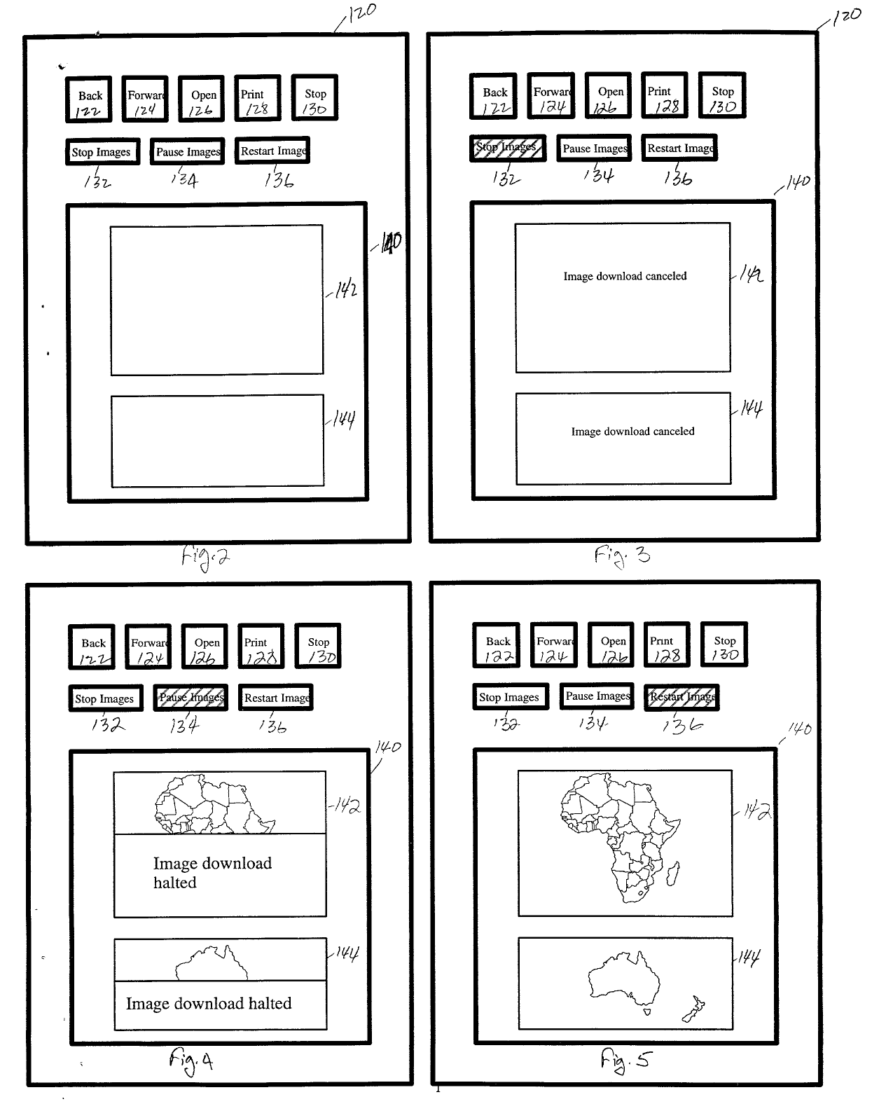

FIGS. 2, 3, 4 and 5 are depictions of a web browser 120. The web browser 120 has a plurality of buttons, buttons 122, 124, 126, 128, 130, 132, 134 and 136, and area 140 within which file documents are displayed. Buttons 122-130 are usually included in most of conventional web browsers. Buttons 132, 134 and 136, however, are part of the present invention. Using hyperlinks (a hyperlink is a hotspot in a displayed document having a reference to another document that includes the web address where the document is located, the document can be downloaded and its content displayed by a mouse click) or URLs (a URL or uniform resource locator is a web address of a document), a user may display one document after another in area 140. After displaying two or more documents, the user may go back displaying the document that was displayed just before the presently displayed document by a mouse click on “BACK” button 122. If the user decides to redisplay the document that was displayed just before using the “BACK” button 122, the user can simply click on “FORW” button 124. “Open” button 126 is used to access and display documents. “PRINT” button 128 is used to print a presently displayed document and “STOP” button 128 is used to stop a request before it has completed. The request can either be to go back or forward displaying a previously displayed document or to display a new document.

Before a document is displayed, the data representing the document is first downloaded from where it is located (usually from a server) to where it will be displayed (usually to a client station). The data is downloaded in blocks. As each block of data is received, it is displayed. Thus, the document is often displayed gradually.

It is well known that image files contain much more data than text files and thus take longer to download. In addition, the more complex the image, the greater the amount of data needed to represent the image. Hence, it can be very frustrating, when displaying a document containing more than one graphic image of which only one (image) is of interest to a user, for the user to wait for the whole document to be downloaded and displayed. Conventional browsers have afforded users the luxury to stop the download of a document by a simple mouse click on the “STOP” button 130. But, as alluded to before, when the stop button is used, the display of the whole document is aborted and not just the images that are not of interest. The present invention provides a mechanism to either suspend or altogether cancel the download of graphic images in a document.

“STOP IMAGES” button 132 of FIGS. 2, 3, 4 and 5 is used to stop displaying all the images of a document. For example, before the continents of Africa and Australia are displayed in areas 142 and 144 respectively, if the “STOP IMAGES” button 132 is selected, the images will not be displayed. Instead, a reminder that the image download was canceled will be displayed (see FIG. 3).

“PAUSE IMAGES” button 134 of FIGS. 2, 3, 4 and 5 is used to suspend or temporarily halt the display of images. When the display of a graphic image is suspended or halted, the part of the image that has already been downloaded will be displayed. There also will be a reminder that the image download was halted (see FIG. 4). To resume downloading and displaying the rest of the data, the user merely needs to click on “RESTART IMAGES” button 136. FIG. 5 depicts two images whose display was resumed after being halted.

“STOP IMAGES”, “PAUSE IMAGES” and “RESTART IMAGES” buttons 132, 134 and 136 are used to stop, suspend and resume, respectively, the display of all the images contained in a web page or document. If, however, the display of one or more images is to be stopped, suspended or resumed mouse 26 can be used. For instance:

(1) when the mouse pointer is over an image that is currently being displayed, if the user holds down the left mouse button, a pull down menu will appear with the following selections: Stop image, Pause image, Restart image and Reload image. If Stop image is selected, the image will not be displayed and a reminder that the image download was canceled will be displayed instead (see FIG. 3). If, on the other hand Pause image is selected, the part of the image that has been displayed thus far will remain on the screen, no more data will be downloaded and a reminder that the display of the image was halted will be displayed (see FIG. 4). (Note that the selections in bold and italics are the only ones that can be chosen.)

(2) When the mouse pointer is over an image whose display had been stopped or completed, if the user holds down the left mouse button, a pull down menu will appear with the following selections: Stop image, Pause image, Restart image, and Reload image. If Reload image is selected, the image will be reloaded from the server.

(3) When the mouse pointer is over an image whose display has been suspended, if the user holds down the left mouse button a pull down menu will appear with the following selections: Stop image, Pause image, Restart image and Reload image. If Restart image is selected, the display of the image will resume at the point that it had stopped. As explained before, if Reload image is selected, the image will be reloaded.

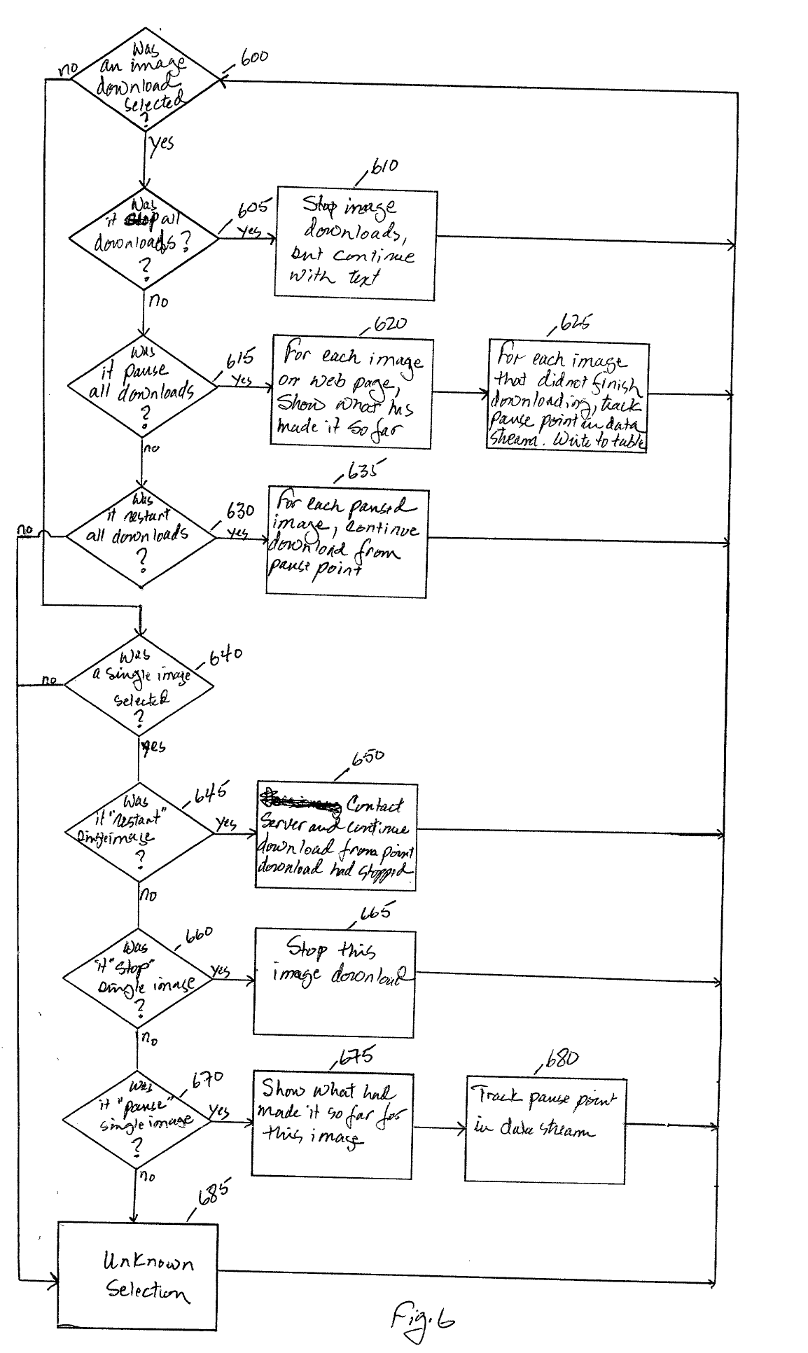

FIG. 6 is a flowchart of the process used in implementing the present invention. At step 600, a check is made as to whether any of buttons 132, 134 and 136 or any one of the selections from the pull down menu is chosen. If there is not a selection from either the buttons or the pull down menu, the process remains at step 600. If one of the buttons was chosen, then it is determined whether the button chosen was “STOP IMAGES” button 132 (step 605), “PAUSE IMAGES” button 134 (step 615) or “RESTART IMAGES” button 136. If the stop button was selected, all image downloads will stop. However, text downloads will continue to occur and the process returns to step 600 (step 610). If the button selected was instead the pause button, the data that has already been received will be displayed and the point at which the download of the image data had stopped will be remembered so that the download of data can be resumed at that point if the restart button is later selected (steps 615, 620 and 625). If the button selected is the restart button, the download of the images will resume at the point it had stopped and the process returns to step 600 (steps 630 and 635).

The invention makes use of the following knowledge. Each file (i.e., image as well as text files) is controlled by a thread in the web browser. The data representing each file in the document is downloaded in blocks. After each block of data is downloaded, each thread acknowledges the receipt of the data, if it did receive data, and apprises the server as to whether it is ready to receive more data. Thus, until the server receives an indication that a thread is ready to accept more data, no data is further transmitted to that thread.

When a user stops or pauses the image download by either using the pull down menu or buttons 132 and 134, the threads controlling the downloads of the image data in the document are instructed not to notify the server of their readiness to accept anymore data. Hence, no image data is further transmitted.

Returning to FIG. 6, if the requested download from step 600 is a single image download (step 640), then it is determined whether it is restart (step 645), stop (step 660) or pause (step 670) single image download. If the selection is restart single image download, the server is contacted and the download continues from the point it had earlier stopped (step 650). If the selection is stop single image download, the image download is stopped (step 665). If, however, the selection is pause single image download, data will cease to be downloaded. All data that has already been downloaded will be displayed and the system will tract the pause point from the data stream (steps 675 and 680). If restart, stop or pause was not selected, then the selection made is unknown and the process returns to step 600.

Although the present invention has been fully described above with reference to specific embodiments, other alternative embodiments will be apparent to those of ordinary skill in the art. Therefore, the above description should not be taken as limiting the scope of the present invention defined by the appended claims.

What is claimed is:

1. A method of controlling web browser document displays, said document being displayed on a display system and having at least a text file and an image file, said method comprising the steps of:
displaying said text file on said display system; and
displaying said image file on said display system only if said image is of interest to a user.

2. The method of claim 1 further including the step of halting displaying said image file while said image file is being displayed.

3. The method of claim 2 further including the step of resuming displaying said image file after halting displaying said image file.

4. The method of claim 2 wherein said step of halting displaying said image file includes the step of stopping downloading data representing said image file to said display system.

5. The method of claim 3 wherein said step of resuming displaying said image file includes the step of resuming downloading data representing said image file to said display system.

6. An apparatus for controlling web browser document displays, said document being displayed on a display system and having at least a text file and an image file, said apparatus comprising:
means for displaying said text file on said display system; and
means for displaying said image file on said display system only if said image is of interest to a user.

7. The apparatus of claim 6 further including means for halting displaying said image file while said image file is being displayed.

8. The apparatus of claim 7 further including means for resuming displaying said image file after halting displaying said image file.

9. The apparatus of claim 7 wherein said means for halting displaying said image file includes means for stopping downloading data representing said image file to said display system.

10. The apparatus of claim 8 wherein said means for resuming displaying said image file includes means for resuming downloading data representing said image file to said display system.

11. A computer program product having computer program code means for controlling web browser document displays, said document being displayed on a display system and having at least a text file and an image file, said apparatus comprising:
computer program code means for displaying said text file on said display system; and
computer program code means for displaying said image file on said display system only if said image is of interest to a user.

12. The computer program of claim 11 further including computer program code means for halting displaying said image file while said image file is being displayed.

13. The computer program of claim 12 further including computer program code means for resuming displaying said image file after halting displaying said image file.

14. The computer program of claim 12 wherein said computer program code means for halting displaying said image file includes computer program code means for stopping downloading data representing said image file to said display system.

15. The computer program of claim 13 wherein said computer program code means for resuming displaying said image file includes computer program code means for resuming downloading data representing said image file to said display system.
